(19) United States
(12) Patent Application Publication
(10) Pub. No.: US 2010/0052414 A1
(43) Pub. Date: Mar. 4, 2010

(54) Bearing Seal Assembly

(76) Inventor: Curt Leaverton, Urbandale, IA (US)

Correspondence Address: Brown, Winick, Graves, Gross, Baskerville;and Schoenebaum, P.L.C, 666 Grand Ave, Suite 2000, Des Moines, IA, 50309, US

(21) Appl. No.: 12/203,633

(22) Filed: Sep. 3, 2008

(51) Int. Cl. B60B 27/06

(52) U.S. Cl. 301/110.5

(57) ABSTRACT

A wheel bearing assembly for motorcycles comprising a hub, a bearing, a bearing seal, a collar, and an axle. A sealing element such as an o-ring, rubber seal or sleeve is provided between the inside surface of the collar and the axle, in a substantially watertight static relationship therewith, so as to prevent moisture from seeping between the collar and the axle disposed therein. The sealing element is preferably retained in a groove machined into the interior surface of the collar, but may be frictionally retained thereby or in a press fit relationship therewith.

### CROSS-REFERENCE TO RELATED APPLICATIONS

None

### BACKGROUND OF THE INVENTION

1. Field of the Invention

The present invention relates generally to wheel bearing assemblies. Specifically, the invention relates to a wheel bearing assembly for motorcycles, and more particularly to the collar or spacer about the axle between the fork and hub in a conventional wheel bearing assembly. A sealing element is provided to prevent harmful moisture from infiltrating and damaging the wheel bearing assembly.

2. Description of the Prior Art

Motorcycle wheel bearing assemblies are well known in the art. In a fairly typical arrangement, one set of bearings resides in the hub on either side of the wheel. A seal is positioned against each of the bearings, and a collar (or spacer) is seated against the bearing in contact with the seal. The axle is inserted into, and a portion thereof resides within, the inner diameter of the collar as well as the bearings. This arrangement effectively blocks moisture that would or could otherwise seep between the collar and hub.

In recent years, motocross racing and recreational dirt bike riding have increased in popularity, as has the relative accessibility and affordability of powerwashing equipment. The use of powerwashers to remove dirt and mud from soiled machines creates a situation in which moisture can seep into places far more often and in considerably greater volume than before. Although moisture infiltration into bearing assemblies is a familiar problem, the increased frequency and volume require owners to repack or even replace the wheel bearings at shorter intervals in order to combat corrosion, premature deterioration and damage caused by moisture.

The aforementioned seal between the bearing and the collar does not prevent moisture from seeping between the two concentric, cylindrical surfaces of the collar and the axle and ultimately reaching the bearing assembly via this route. A need therefore exists for an improved wheel bearing assembly.

### SUMMARY OF THE INVENTION

The present invention relates to a wheel bearing assembly such as that used in motorcycles comprising a hub, a bearing, a bearing seal, a collar and an axle. A sealing element such as an o-ring, rubber seal or sleeve is provided between the inside surface of the collar and the outside surface of the axle, in a static relationship therewith, so as to prevent moisture from seeping between the collar and the axle disposed therein. The sealing element is preferably retained in a groove machined into the surface of the collar, but may also be retained by a groove in the axle, a lip and a friction fit or by resiliency of the sealing element and a friction fit, or by a press fit between a seal and the collar.

It is a first object of the present invention to provide an inexpensive and relatively simple solution to moisture seepage within the internal members of a wheel bearing assembly.

It is a further object of the present invention to provide a wheel bearing assembly that can be readily and economically retrofitted onto existing motorcycles.

Other objects, features, and advantages of the present invention will be readily appreciated from the following description. The description makes reference to the accompanying drawings, which are provided for illustration of the preferred embodiment. However, such embodiment does not represent the full scope of the invention. The subject matter which the inventor does regard as his invention is particularly pointed out and distinctly claimed in the claims at the conclusion of this specification.

### BRIEF DESCRIPTION OF THE DRAWINGS

FIG. 1 is an exploded view of a prior art wheel bearing assembly.

FIG. 2 is a perspective, partial cutaway view of a wheel bearing assembly of the present invention.

FIG. 3 is an end view of a prior art wheel bearing assembly taken along line 3-3 of FIG. 2.

FIGS. 4a and 4b are perspective views of prior art collars.

FIGS. 5a and 5b are perspective views of embodiments of the collars of the present invention.

FIG. 6 is a perspective view of an alternative embodiment of the collar of the present invention.

FIG. 7 is a perspective view of an alternative embodiment of the axle of the present invention.

FIG. 8 is an end view taken along line 3-3 of FIG. 2.

### DETAILED DESCRIPTION OF THE PREFERRED AND OTHER EMBODIMENTS

While the making and using of various embodiments of the present invention are discussed in detail below, it should be appreciated that the present invention provides for inventive concepts capable of being embodied in a variety of specific contexts. The specific embodiments discussed herein are merely illustrative of specific manners in which to make and use the invention and are not to be interpreted as limiting the scope of the instant invention.

As used herein, “motorcycle” shall include, without limitation, motorcycles, dirt bikes, motor bikes, street bikes and other similar vehicles.

“Collar” should be interpreted to include “spacer”, as that term is also known and used in the art, and vice versa. However, “bearing spacer” herein refers only to that spacer (sometimes referred to as the middle bearing spacer) passing through the hub and engaged at either end by a bearing.

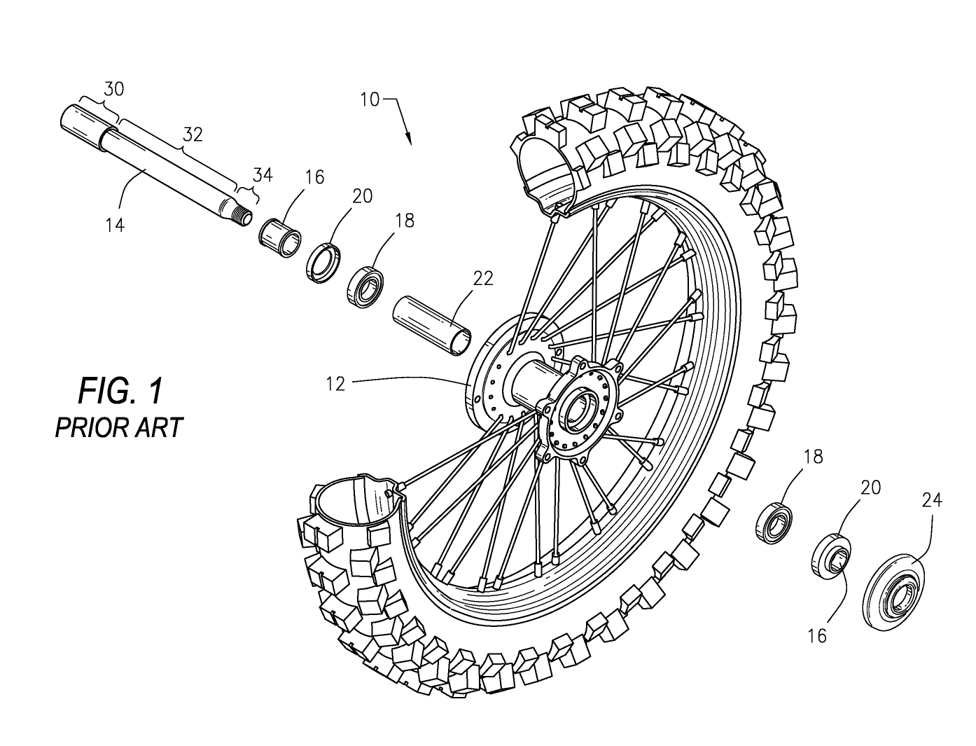

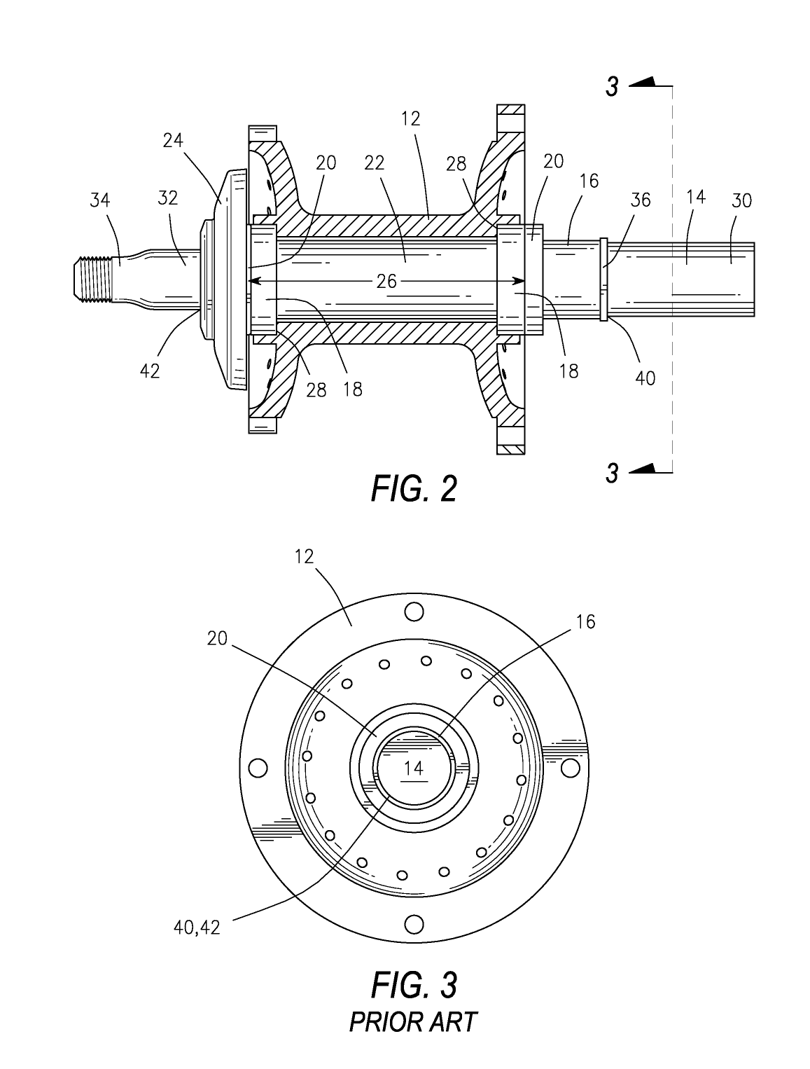

In FIG. 1, a conventional motorcycle wheel bearing assembly 10 is depicted. As is well known in the art, assembly 10 comprises a hub 12, axle 14, collars 16, bearings 18, bearing seals 20, and a bearing spacer 22. One or both collars 16 may have a dust shield 24. Referring now to FIG. 2, a bore 26 having a first inner diameter (ID) is centrally disposed through and traverses hub 12. In many embodiments, one or both ends of bore 26 are characterized by a concentric seat 28. Seat 28 defines a second, larger ID at the ends of bore 24. It will be appreciated that the difference in diameter between the first ID and the second ID of bore 26 is twice the length of seat 28.

Axle 14 is an elongate cylindrical member having a first end 30, a mid-section 32 comprising a majority of the length of thereof, and a second end 34. First end 30 of axle 14 is preferably larger in diameter than mid-section 32. Mid-section 32 is, in turn, preferably larger in diameter than second end 34. Second end 34 of axle 14 is typically externally threaded for engagement with an internally threaded fork or a conventional nut. By way of comparison, the outer diameter (OD) of mid-section 32 is smaller than the first inner ID of bore 26 of hub 12.

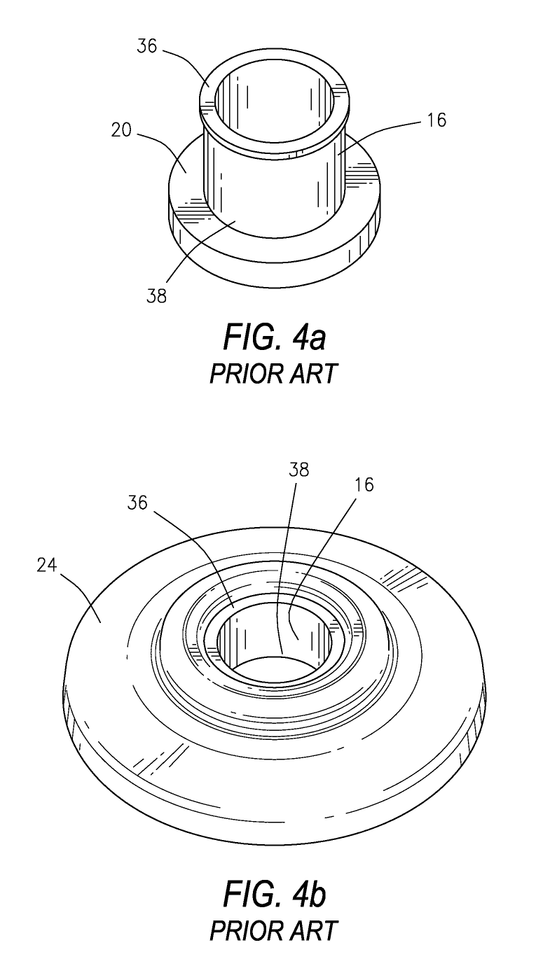

With respect to FIGS. 4a and 4b, each collar 16 is a hollow cylindrical member having an inner and outer diameter, as well as a distal end 36 and a proximal end 38, “distal” and “proximal” in this instance being relative to hub 12 and bearing 18. Collar 16 is typically situated between a fork (not shown) at or near distal end 36 and hub 12 at or near proximal end 38. If present, dust shield 24 is statically situated or affixed at or about distal end 36 of collar 16. While many such dust shields of varying size and shape are known in the art, dust shield 24 is substantially a hollow, truncated cone with a central opening adapted to receive collar 16, and distal end 36 of collar 16 may or may not protrude from the truncated end thereof.

The ID of collar 16 is only slightly larger than the diameter of mid-section 32 of axle 14, but smaller than the diameter of first end 30, so as to permit collar 16 to slidably fit over both second end 34 and mid-section 32 of axle 14, but not first end 30. Turning to FIG. 2, junction 40 is formed where distal end 36 of collar 16 engages first end 30 of axle 14. Junction 42 is formed where distal end 36 of opposite collar 16 engages axle 14, proximate second end 34.

Bearing 18 is a conventional wheel bearing assembly such as a ball bearing and is a hollow cylindrical member having an OD defined by an outer race and an ID defined by an inner race. The OD of bearing 18 is substantially the same as or only very slightly smaller than the second ID of bore 26 of hub 12 (or first ID, if no seat 28 is present) such that bearing 18 has an interference or press fit within hub 12. Where seat 28 is present within hub 12, bearing 18 resides on seat 28.

Bearing seal 20 is a conventional seal such as an oil seal and has an OD and an ID. The OD of bearing seal 20 is substantially the same as second ID of bore 26 of hub 12 (or first ID, if no seat 28 is present) such that bearing seal 20 frictionally and statically engages hub 12, particularly when bearing seal 20 is seated on bearing 18. The ID of bearing seal 20 is substantially the same as, or very slightly larger than, the OD of collar 16 so as to permit bearing seal 20 to be frictionally engaged with and situated about the proximal end 38 of collar 16. It will be appreciated that as shown in FIG. 3, bearing seal 20 forms a dynamic, substantially watertight seal over bearing 18 (not visible in FIG. 3) between hub 12 and collar 16.

Bearing spacer 22 is a hollow, cylindrical member having an OD that is smaller than the first ID of bore 26 of hub 12, and an ID that is only slightly larger than the diameter of mid-section 32 of axle 14. The length of bearing spacer 22 will vary depending on the size and type of wheel. Persons skilled in the art will appreciate that the length of bearing spacer 22 ultimately will depend on the lateral spacing desired between bearings 18. When installed, bearing spacer 22 will engage a bearing 18 at each end.

Still referring to FIG. 3, it will be appreciated that at junctions 40, 42, the space or gap between concentric and cylindrical axle 14 and collars 16 is relatively small but provides an opportunity for moisture to seep into or penetrate wheel bearing assembly 10. This risk is heightened when water is under pressure, such as during routine powerwashing.

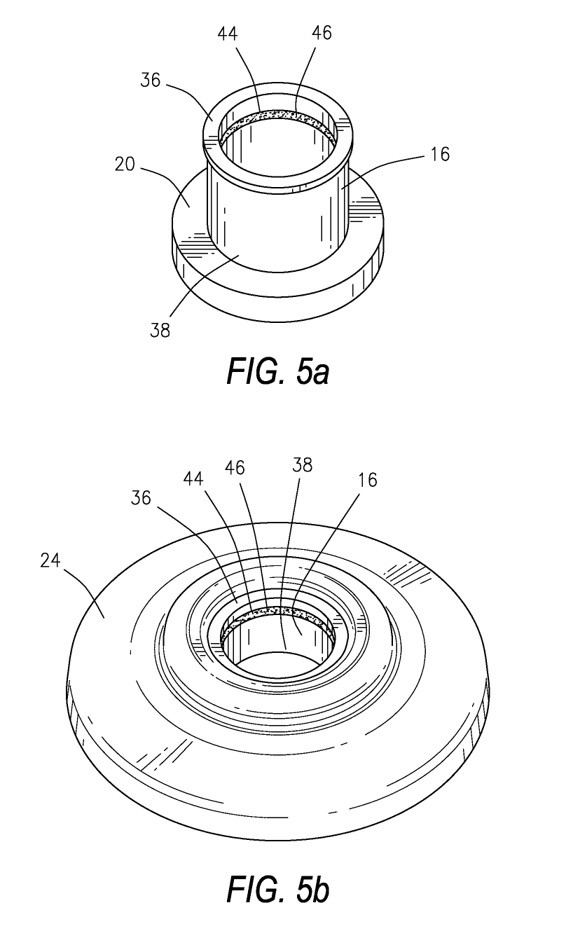

Turning to FIGS. 5a and 5b, in an embodiment of the present invention, the internal surface of collar 16 is provided with a means 44 for retaining a sealing element, such as a circumferential recessed portion, notch, channel or groove. Retaining means 44 is preferably situated at or near the distal end 36 of collar 16. Alternatively, collar 16 may be provided with a retaining means 44 located anywhere between the distal end 36 and proximal end 38 of collar 16, or even at or near proximal end 38. It will be appreciated, however, that the placement of retaining means 44 at or near an end such as distal end 36 facilitates machining and contributes to ease of manufacture of collar 16. Retaining means 44 may be rectangular, semicircular, angular or any other suitable shape, and is adapted to partially receive a sealing element 46, preferably an o-ring. Without limitation, exemplary o-rings 46 include any suitable conventional o-ring such as a Parker® (PARKER-HANNIFIN CORP., Cleveland, Ohio) 674-70 nitrile. Persons skilled in the art will appreciate that the selection of an o-ring includes the determination of various tolerances, properties, hardness (durometer) and other specifications depending on the specific application or requirements.

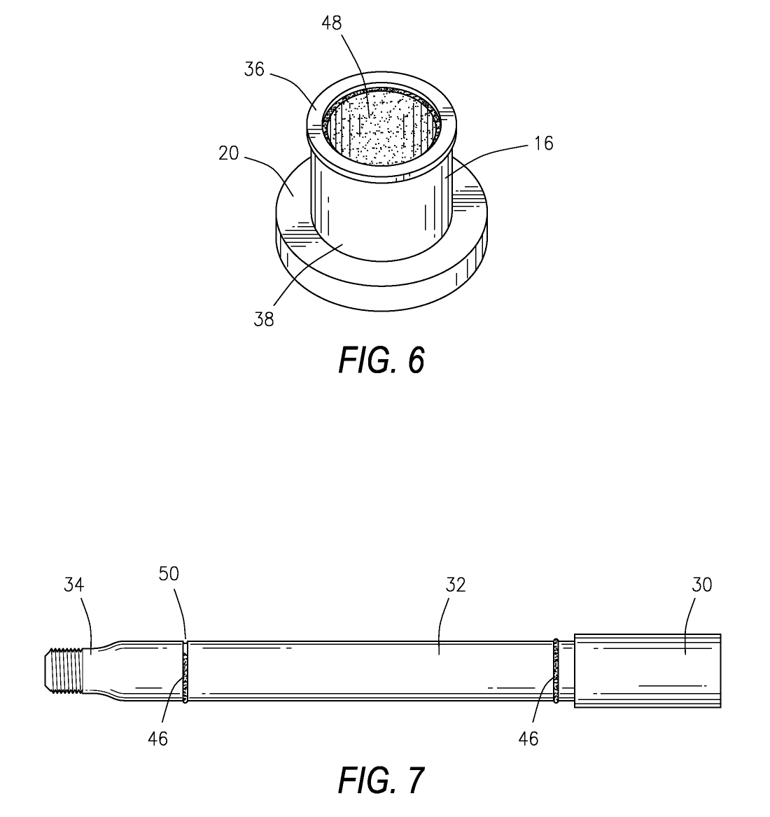

Sealing element 46 could be a conventional rubber seal engaged with the internal surface of collar 16 in a press fit. In yet another embodiment shown in FIG. 6, the internal surface of collar 16 is lined with a sleeve 48 of resilient material. In still another embodiment, an o-ring is retained within collar 16 without a retaining means or groove. Alternatively, as shown in FIG. 7, a retaining means 50 such as a circumferential recessed portion, notch, channel or groove may be provided on the external surface of that portion of axle 14 around which collar 16 is situated. Likewise, that portion of axle 14 around which collar 16 is situated may be lined with a sleeve of resilient material.

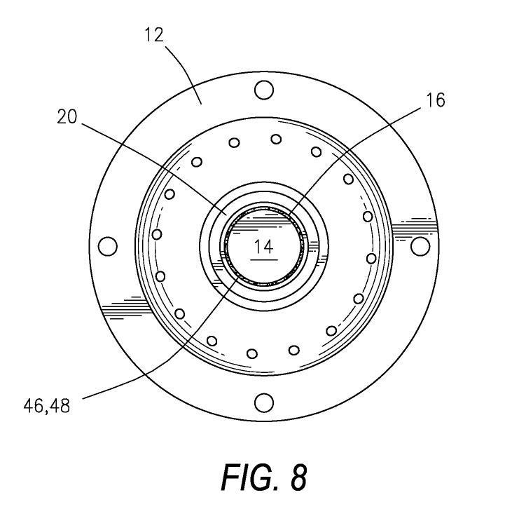

When assembled, mid-section 32 of axle 14 frictionally engages seal 46 or sleeve 48, thereby forming a static, substantially watertight seal between collar 16 and axle 14. Turning to FIG. 8, working from inside outward, the concentric relationship of axle 14, seal 46 (or sleeve 48), collar 16, bearing seal 20 and hub 12 is shown. By way of comparison, an end view of the prior art assembly is shown in FIG. 3. It will be appreciated that the opportunity for moisture to infiltrate or penetrate wheel bearing assembly 10 is reduced or eliminated by way of the presence of seal 46 (or sleeve 48).

Thus, the present invention has been described in an illustrative manner. It is to be understood that the terminology that has been used is intended to be in the nature of words of description rather than of limitation. Furthermore, whereas the present invention has been described in relation to the drawings attached hereto, it should be understood that other and further modifications, apart from those shown or suggested herein, may be made within the spirit and scope of this invention.

What I claim is:

1. In combination with a motorcycle wheel bearing assembly having a hub, a bearing, a bearing seal, a collar adjacent said bearing, and an axle disposed through said hub, bearing and collar, wherein said bearing seal is engaged with each of said hub, said bearing and said collar, the improvement which comprises:
a sealing element disposed between and in static engagement with said collar and said axle.

2. The improvement of claim 1 wherein the inside of said collar further comprises a means for retaining said sealing element.

3. The improvement of claim 2 wherein said retaining means is a recessed portion and said sealing element is partially disposed within said recessed portion.

4. The improvement of claim 1 wherein the outside of said axle further comprises a recessed portion and said sealing element is partially disposed within said recessed portion.

5. The improvement of claim 1 wherein said sealing-element is an o-ring.

6. The improvement of claim 1 wherein said sealing element is a resilient sleeve.

7. The improvement of claim 1 wherein said sealing element is a rubber seal.

8. The improvement of claim 3 wherein said recessed portion is a circumferential groove provided in said collar distally from said bearing.

9. The improvement of claim 4 wherein said recessed portion is a circumferential groove provided on said axle distally from said bearing.

10. The improvement of claim 1 wherein said static engagement between said axle, said collar and said sealing element is substantially watertight.

11. A wheel bearing assembly for motorcycles comprising:
a hub having a bore centrally disposed therethrough;
an axle partially disposed within said bore;
a bearing around a first portion of said axle;
a cylindrical collar adjacent said bearing, said collar being around a second portion of said axle external to said bore;
a bearing seal engaged around and in a dynamic relationship with said collar, said bearing seal farther being in a static engagement with each of said hub and said bearing; and
a sealing element disposed between said collar and said second portion of said axle;
wherein said sealing element is in static engagement with each of said collar and said second portion of said axle.

12. The wheel bearing assembly of claim 11 wherein the inside surface of said collar further comprises a means for retaining said sealing element.

13. The wheel bearing assembly of claim 12 wherein said retaining means is a recessed portion and said sealing element is partially disposed within said recessed portion.

14. The wheel bearing assembly of claim 11 wherein the outside surface of said second portion of said axle further comprises a recessed portion and said sealing element is partially disposed within said recessed portion.

15. The wheel bearing assembly of claim 11 wherein said sealing element is an o-ring.

16. The wheel bearing assembly of claim 1 wherein said sealing element is a resilient sleeve.

17. The wheel bearing assembly of claim 11 wherein said sealing element is a rubber seal.

18. The wheel bearing assembly of claim 14 wherein said recessed portion is a circumferential groove provided in said collar distally from said bearing.

19. The wheel bearing assembly of claim 14 wherein said recessed portion is a circumferential groove provided on said second section of said axle distally from said bearing.

20. The wheel bearing assembly of claim 11 wherein said static engagement between said axle, said collar and said sealing element is substantially watertight.
